(19) United States
(12) Patent Application Publication
(10) Pub. No.: US 2007/0163227 A1
(43) Pub. Date: Jul. 19, 2007

(54) Nozzles with rotatable sections for variable thrust

(75) Inventors: Stephen A. Mano, Flint Hill, VA (US); Robert E. Black III, Centreville, VA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Aerojet-General Corporation, Sacramento, CA (US)

(21) Appl. No.: 11/334,778

(22) Filed: Jan. 17, 2006

(51) Int. Cl. F02K 9/68

(52) U.S. Cl. 60/200.1

(57) ABSTRACT

Thrust variability in a nozzle is achieved by constructing the nozzle in two parts, one of which is rotatable relative to the other. The nozzle includes a convergent section, a throat, and a divergent section, all of which are formed in the annular region between a centerbody and a shell. The rotation produces a variation in the cross-sectional area of the nozzle by bringing apertures in the two parts into and out of alignment and thereby partially or fully opening and closing the flow passage through the convergent section, throat, and divergent section.

### BACKGROUND OF THE INVENTION

1. Field of the Invention

This invention resides in the technology of nozzle design for thrust applications.

2. Description of the Prior Art

A rocket-powered launch vehicle requires high thrust at takeoff due to the large amount of unburnt fuel initially present in the vehicle. Most such vehicles are designed to be launched from the earth's surface, typically at sea level, and then to cruise at high altitude where the external pressure is lower and is often at high vacuum. Since the vehicle performs its primary mission at the high cruising altitude, the vehicle must produce a high specific impulse (Iₛₚ) at takeoff to reach this altitude if the mission is to be performed effectively. The specific impulse Iₛₚ is the ratio of thrust to the weight of fuel consumed per unit time, and a high Iₛₚ is most readily achieved when the engine has a nozzle with a high area ratio, which is the ratio of the area at the nozzle exit to the area at the throat. Nozzles with high area ratios tend to produce relatively low thrust at sea level, however, because the wall pressure inside the nozzle near the nozzle exit is below ambient pressure, resulting in a reverse pressure differential between the combustion gases and the atmosphere which produces a negative thrust component.

The prior art includes a variety of nozzle designs that seek to eliminate this negative component of the sea level thrust without compromising the thrust in a high-vacuum environment. These designs generally involve mechanisms for varying the nozzle area in a manner that reduces the area at the exit for launch and then increases the area during ascent. The variability is achieved in the prior art by constructing the nozzle with features that allow adjustments to be made to the contour, area ratio, and length of the nozzle as the vehicle altitude increases. Unfortunately, these features add complexity to the engine construction and increase the engine weight. Thrust variability has also been achieved by the use of combination-type engines that burn different fuels at different stages. Examples of such combinations are kerosene-fueled engines combined with engines derived from the Space Shuttle Main Engine (SSME), kerosene-fueled engines combined with hydrogen-fueled engines such as the Russian RD-701 engine, the dual-fuel-dual-expander engine concept described by Beichel, R., in U.S. Pat. No. 4,220,001 (issued Sep. 2, 1980), and the dual-thrust rocket motor of Bornstein, L., U.S. Pat. Nos. 4,137,286 (issued Jan. 30, 1979) and 4,223,606 (issued Sep. 23, 1980). The Beichel engine requires a complex nozzle design that incorporates two thrust chambers, while the Bornstein motor achieves dual thrust by using separate booster and sustainer propellant grains in the combustion chamber, together with an igniter and squib that are inserted into the grain itself. A further alternative is the introduction of secondary combustion gas near the wall of the divergent section of the nozzle, as described by Bulman, M., in U.S. Pat. No. 6,568,171 (issued May 27, 2003). Still further alternatives are pintle nozzles, an example of which is described by Morris, J. W., et al., in U.S. Pat. No. 5,456,425 (issued Oct. 10, 1995).

The need for multiple thrust levels also arises in rocket motors other than launch vehicles. In rocket motors in general, the typical thrust levels are “boost” and “sustain,” enabling the rocket both to travel long distances to reach distant targets and to close in on nearby targets. As in launch vehicles, a common means of varying the thrust level has been the use of pintles for active throat area control.

### SUMMARY OF THE INVENTION

The present invention resides in a variable thrust nozzle with a two-part construction, one part of which is rotatable relative to the other. The parts are constructed such that the rotation produces a variation in the cross-sectional area of the nozzle and hence in the thrust produced by the nozzle. The nozzle contains a centerbody and a shell, and the flow passages for the combustion gas, which include a convergent section, a throat, and a divergent section, are formed in the annular gap between the centerbody and shell. In certain embodiments of the invention, a small nozzle is formed in the centerbody as well for added continuity of thrust. In all embodiments, however, the rotation partially opens and closes the flow passage through the gap to vary the flow rate of combustion gas that the gap will allow to pass. This variability in flow rate causes variability in the thrust. The invention is capable of implementation in a variety of nozzle designs, preferably those that are generally in the form of bodies of revolution about a central axis. Spike and aerospike nozzles are examples, as are multiple nozzle configurations that contain a series of small nozzles encircling the centerbody. Among the many advantages of this invention are the small amount of space that is consumed by the variable thrust mechanism compared to multiple thrust nozzles of the prior art, and the ability to incorporate multiple thrust levels by simple variations in the configurations and number of flow passages.

These and other features, embodiments, and advantages of the invention will be apparent from the description that follows.

### BRIEF DESCRIPTION OF THE DRAWINGS

FIG. 1 is a cross section of a nozzle incorporating the features of the present invention.

FIG. 2 is a perspective view of two components of the nozzle of FIG. 1, separated for ease of visibility.

FIG. 3 is a perspective view of the nozzle of FIG. 1.

FIG. 4 is a perspective view of a second nozzle incorporating the features of the present invention.

FIG. 5 is a perspective view of a third nozzle incorporating the features of the present invention.

FIG. 6 is a view from the aft side of the rotary and stationary parts of the nozzle of FIG. 5, the parts separated for ease of visibility.

FIG. 7 is a view of the same two parts depicted in FIG. 6 but in full contact, with the rotating part in one angular position.

FIG. 8 is a view of the same two parts depicted in FIGS. 6 and 7, with the rotating part in a different angular position than that of FIG. 7.

### DETAILED DESCRIPTION OF THE INVENTION AND PREFERRED EMBODIMENTS

In the rotary construction of the nozzles of the present invention, rotation occurs about the central longitudinal axis of the nozzle, i.e., the axis in the direction of flow of combustion gases through the nozzle. Variability, as noted above, is achieved by the rotation of one part relative to the other, which can be achieved with one of the two parts being rotatable and the other fixed or with both being rotatable independently. For convenience, however, the two parts will be referred to herein as a rotary part and a stationary part. The flow path of the combustion gases passes through apertures in each of the two parts, and the rotation of one part relative to the other brings the apertures into and out of alignment, varying the degree of overlap between the apertures and therefore the cross-sectional area of the passage through the nozzle. In certain embodiments of the invention, the apertures in one of the two parts are identical in number, shape, and placement to those of the other part while in other embodiments, the apertures differ between the two parts in number, shape, size, placement, or combinations of these parameters. The choice may affect the range of variability of the cross-sectional area of the flow path but is primarily a design consideration governed by the size of the nozzle and the desired magnitude and range of the thrust. The term “variation in the degree of overlap” and similar terms appearing in this specification and the appended claims are used broadly to include the change between full blockage and full opening of apertures, as well as changes in the cross sections of individual apertures, and the shift from one set of apertures to another set of apertures of different size from those of the first set. The rotation can thus result in variations in the sizes of overlapping portions of apertures, or in the full opening and full closing of individual apertures to vary the total number of apertures through which the combustion gases can flow, or in the full opening and full closing of individual apertures combined with differences in cross-sectional area among the individual apertures. Still further alternatives and variations will be readily apparent to those skilled in the art. The apertures can be at any point along the direction of the longitudinal axis of the nozzle—they can thus reside in the convergent section, in the throat plane, or in the divergent section, or extend into two or all three of these locations.

The two parts of the nozzle are preferably arranged with one part fore of the other. In these arrangements, the apertures of at least one of the two parts are positioned at or near the throat. In further preferred constructions, the apertures of one of the two parts span or extend across the throat while the apertures of the other part reside in the divergent section.

While the construction is generally characterized herein as a nozzle with a convergent section, a throat, and a divergent section, the apertures themselves in certain embodiments of the invention can be individual nozzles, each forming its own convergent section, throat, and divergent section. The nozzle will then be a multiple nozzle consisting of several (i.e., a plurality) of individual nozzles, which can also be termed “sub-nozzles” to distinguish them from the overall nozzle construction. The sub-nozzles can be distributed around the centerbody, and the effect of the rotation will be to close individual sub-nozzles, the number closed varying with the degree of rotation. Also, as stated above, the individual sub-nozzles can themselves vary in size and the rotation can vary the selection of individual sub-nozzles to open sub-nozzles of different size without changing the total sub-nozzles left open. For these multiple nozzles, the terms “convergent section,” “throat,” and “divergent section” when referring to the multiple nozzle as a whole will thus be the collective convergent sections, throats, and divergent sections of the individual sub-nozzles.

The apertures of both the rotary and stationary parts of the nozzle are distributed around the centerbody, which resides on the longitudinal axis of the nozzle. The centerbody can form a portion of the nozzle contour, as do the centerbodies of nozzles such as spike nozzles, aerospike nozzles, and expansion-deflection nozzles. Alternatively, the centerbody may simply serve as a structural support for rotating parts. The centerbody is preferably axisymmetric about the longitudinal axis of the nozzle and may taper in the aft direction. In spike nozzles, the centerbody will taper to a sharp aft terminus, for example, while in aerospike nozzles, the centerbody will form a truncated taper, terminating in a plane that is perpendicular to the nozzle axis.

While the novel features defining this invention can implemented in a wide range of nozzle constructions, an understanding of the features that define this invention can be gained by a detailed review of specific embodiments of the invention. Several such embodiments are depicted in the Figures and described below.

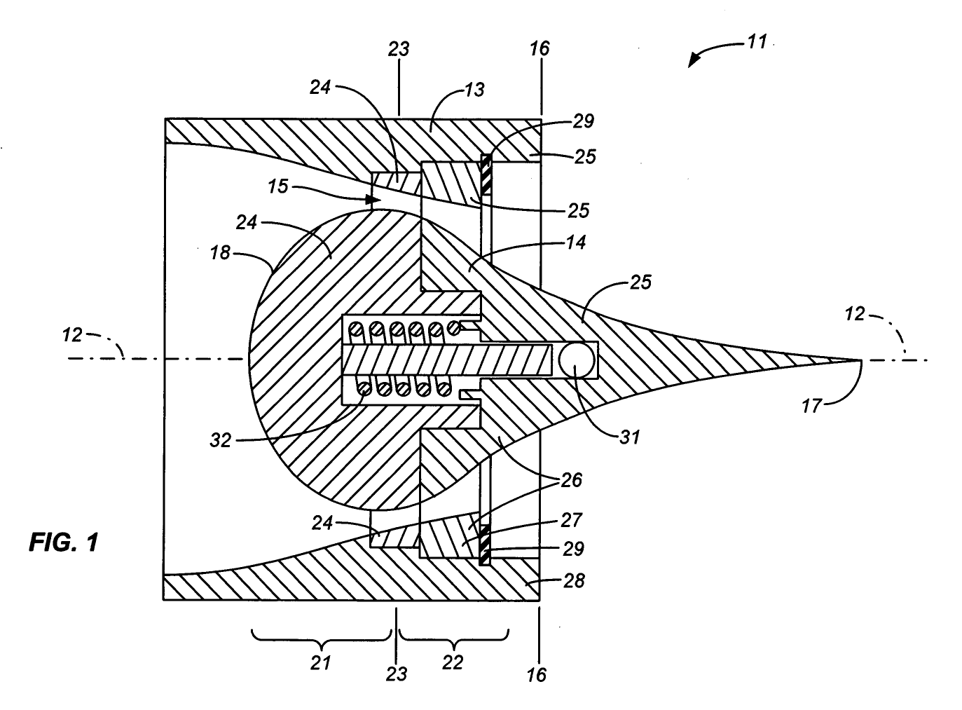

FIG. 1 depicts a spike nozzle 11 incorporating the features of the invention, in cross section. The nozzle is a body of revolution about a longitudinal axis 12, and the cross section is in a plane that includes the longitudinal axis. The nozzle is constructed with a shell 13 and a centerbody 14, and an annular passage 15 between the shell and centerbody. The combustion gases flow through the nozzle in the direction from left to right in the view shown in the Figure, with the combustion chamber (not shown) to the left of the depicted components. The fore direction of the nozzle and hence the direction of thrust are to the left, while the aft direction is to the right. The centerbody 14, as in typical spike nozzles of the prior art, protrudes from the aft end 16 of the shell 13. The profile of the protruding portion of the centerbody consists of two opposing concave curves, tapering to a point 17. The fore end of the centerbody 14 is a rounded dome 18. Due to the curvature of the surface of the centerbody 14 and the curvature of the internal wall surface of the shell 13, the annular passage 15 includes a convergent section 21 and a divergent section 22 at opposite sides of the throat plane 23. As in spike nozzles of the prior art, the combustion gases continue to diverge as they pass the aft end 16 of the shell 13. The features described in this paragraph are features shared by the present invention and the prior art.

As described in the Summary of the Invention above, the novelty of this invention resides in the two-part nozzle construction, one part rotatable relative to the other. In the embodiment shown in FIG. 1, one of the two parts is a fore part 24 which includes the dome 18 of the centerbody 14 and a portion of the shell. The other part 25 is the remainder of the shell 13 plus the aft section of the centerbody 14, including the tapering portion. In this embodiment, the rotating part is the fore part 24 which rotates about the longitudinal axis 12, while the aft part 25, including the major portion of the shell 13, remains stationary. The aft or stationary part 25 in this embodiment is itself in two parts, a central part 26 that includes the aft section of the centerbody 14 and a peripheral ring 27, and an outer shell 28. A retaining ring 29 holds the central part 26 inside the outer shell 28. Rotation of the rotating part 24 relative to the stationary part 25 is facilitated by a ball bearing 31 and driven by a torsion spring 32. The tension on the torsion spring 32 is controlled by externally applied forces, the mechanism of which is not shown but will be readily apparent to those skilled in the art. The torsion spring 32 can be replaced by any of a variety of alternatives, such as cogs, ribs, or struts, and the range of rotation can be defined by stops, tracks, or other conventional structural features that limit a range of motion.

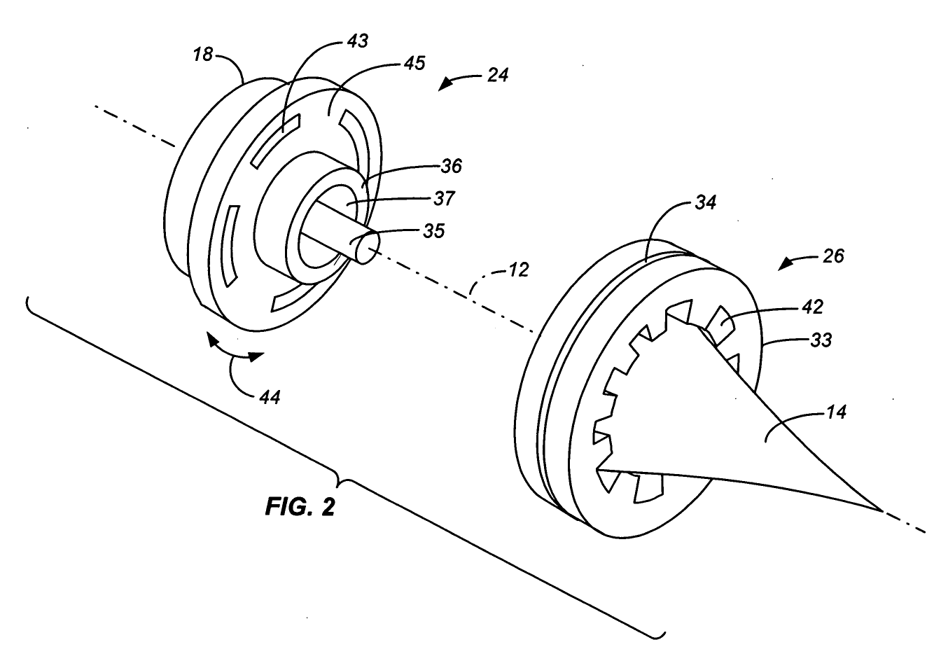

FIG. 2 is a perspective view of the rotary part 24 and central part 26 of the stationary part 25, separated from each other for ease of visibility. The outer extremity of each part is a circular rim, and the outer rim 33 of the stationary part is contains a groove 34 for an o-ring. Extending from the aft face of the rotary part 24 is an axial cylindrical rod 35 encircled by a hollow cylinder 36 with a cavity 37 in between. The torsion spring 32 (shown only in FIG. 1) is retained in the cavity 37.

The central stationary part 26 is of unitary construction in the form of a single rigid piece, including the aft portion of the centerbody 14 which is integrated with the piece. The rotary part 24 is likewise a single rigid piece of unitary construction and includes the fore part of the centerbody (of which the main section is the dome 18) which is likewise integrated with the piece. The annular space 15 shown in FIG. 1 is formed in part by a set of aft apertures 42 formed in the stationary part 26 and a set of fore apertures 43 in the rotary part 24. Both sets of apertures are distributed symmetrically around the centerbody 14 and hence likewise around the axis 12 of the nozzle. Although the aft apertures 42 and the fore apertures 43 differ in shape and number in this embodiment, when aligned they form axial passages each with a continuous axial contour along their inner and outer surfaces (the inner surface being the surface of the centerbody 14). The continuous contours are visible in the cross section in FIG. 1 where the two parts are in contact.

In FIG. 2, the rotation of the rotary part 24 is indicated by the arrow 44. Between each pair of adjacent apertures 43 in the rotary part are solid walls 45 that close the fore side entrances of apertures 42 of the stationary part 26 when they extend over those apertures. Rotation of the rotary part will thus open or close apertures 42 of the stationary part or do so to varying degrees. Thus, all of the apertures 42 may be open when the rotary part 24 is in one angular position while half of the apertures may be closed when the rotary part 24 is in another angular position. With different aperture sizes and configurations, it will be apparent that different variations and combinations of open apertures and aperture sizes can be readily devised.

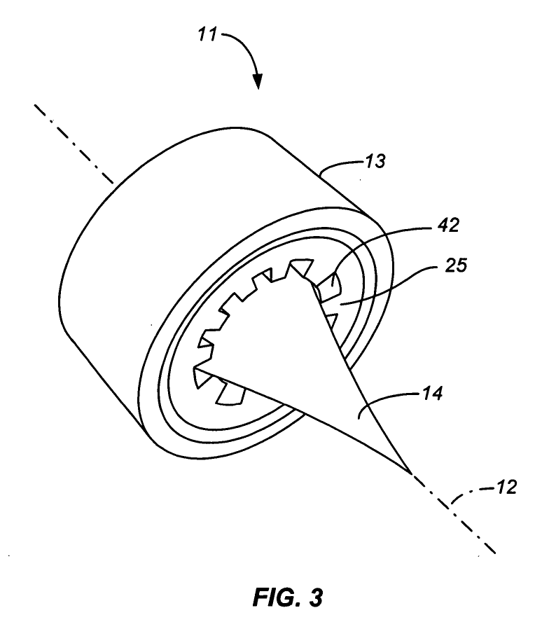

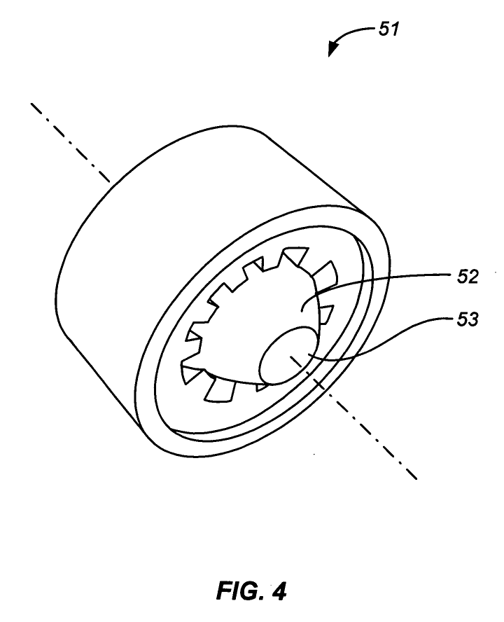

FIG. 3 is a perspective view of the assembled parts of FIG. 2 together with the outer shell 13. FIG. 4 is a corresponding view of an aerospike nozzle 51. All parts in this nozzle are identical to their counterparts in the spike nozzle 11 of the preceding figures with the exception of the centerbody 52 which in the aerospike nozzle of FIG. 4 is a truncated taper, terminating in a flat plane 53 perpendicular to the nozzle axis 12.

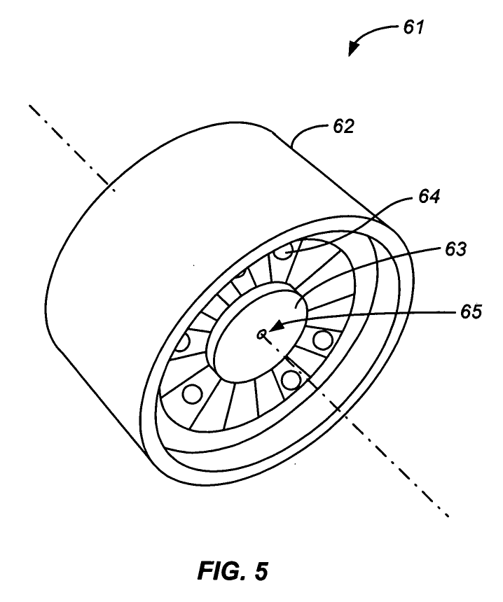

FIG. 5 is a perspective view of a multiple nozzle 61 in accordance with the present invention. As in the nozzles of the preceding figures, the multiple nozzle includes a shell 62, a centerbody 63, and apertures 64 of which only those of the stationary part are visible. The construction of each of these components differs from those of the preceding figures. Each aperture 64 in the nozzle of FIG. 5 is a separate convergent-divergent nozzle with a convergent section, a divergent section, and a throat all contained within the aperture. These apertures are referred to herein as “sub-nozzles” to distinguish them from the multiple nozzle as a whole, and are specifically referred to as “peripheral sub-nozzles” in view of their peripheral positions around the centerbody 63. At the center of the centerbody 63 and aligned with the nozzle axis 12 is a further aperture 65 which is likewise a sub-nozzle. Aside from the central (axial) subnozzle, the centerbody 63 is simply a structural support for the peripheral sub-nozzles 64. In this multiple nozzle, as in the nozzles of the preceding figures, the aft portion of the centerbody 63 is stationary, as are the aft apertures 64 and the shell 62.

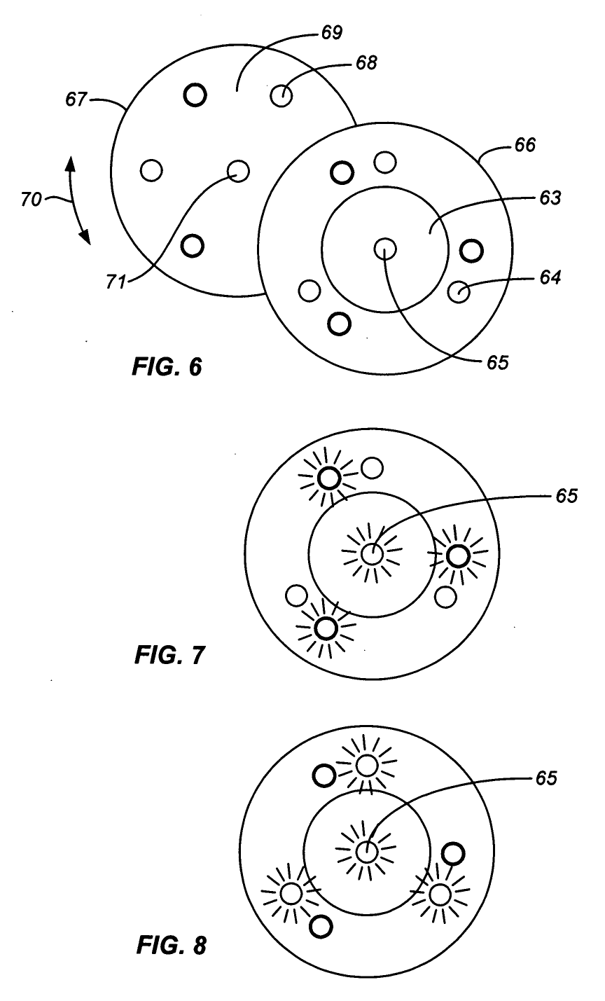

As in the nozzles of the preceding figures, the centerbody 63 in this embodiment is integral with the frame 66 supporting the peripheral sub-nozzles 64. The aft face of the centerbody 63 and the peripheral sub-nozzle frame 66 are shown in FIG. 6, together with the aft face of the rotary part 67 of the nozzle, the rotary part 67 shown offset from the peripheral sub-nozzle frame 66 for ease of visibility. The rotary part 67 is positioned fore of the peripheral sub-nozzle frame 66 and can be joined to the frame by a rotary linkage similar to the rotary linkage shown in FIG. 1 between the stationary and rotary parts of the spike nozzle.

The peripheral sub-nozzle frame 66 in the embodiment of FIGS. 5 and 6 supports six peripheral sub-nozzles 64. These sub-nozzles are of two sizes, three having a narrower cross-sectional flow area than the remaining three. The rotary part 67 contains six apertures 68, each adjacent pair of these apertures separated by a solid wall 69. The rotary part is rotated in the direction indicated by the arrow 70, and at any angle of rotation, three of the peripheral sub-nozzles 64 of the stationary part are blocked by a solid wall 69. The rotary part 67 can thus be rotated into position to open the three small peripheral sub-nozzles to achieve firing shown in FIG. 7, or into position to open the three large peripheral nozzles to achieve firing shown in FIG. 8. The rotary part can also be rotated further to close off all peripheral sub-nozzles. The rotary part 67 also contains a central aperture 71 that is aligned with the central sub-nozzle 65 of the stationary part at all times. Different thrust levels through the nozzle as a whole are achieved by different rotary positions while a minimal level of thrust is continually present through the central sub-nozzle 65.

The foregoing is offered primarily for purposes of illustration. Further variations and modifications that utilize the novel features of this invention and therefore also fall within the scope of this invention will readily occur to the skilled propulsion engineer.

What is claimed is:

1. In a nozzle comprising a centerbody and a shell with an annular gap therebetween, said annular gap comprising a convergent section, a throat, and a divergent section,
the improvement wherein said rocket nozzle comprises first and second parts, each said part comprising a plurality of apertures distributed around said centerbody, said first part being rotatable relative to said second part to cause apertures of said first part to overlap with apertures of said second part to a variable degree and thereby provide said nozzle with a variable thrust by providing said flow passage with a variable cross-sectional area.

2. The nozzle of claim 1 wherein said first part is fore of said second part.

3. The nozzle of claim 1 wherein said apertures of said first part extend across said throat and said apertures of said second part reside in said divergent section.

4. The nozzle of claim 1 wherein said first part is fore of said second part and said apertures of said first part extend across said throat.

5. The nozzle of claim 1 wherein said apertures of said first part and said apertures of said second part are configured such that said first part can be rotated from a position wherein all apertures of said second part are aligned with apertures of said first part and thereby open to flow of combustion gases to a position wherein some, but not all, of said apertures of said second part are fully closed by said first part.

6. The nozzle of claim 1 wherein said nozzle has fore and aft ends, and said centerbody is axisymmetric and tapers toward said aft end.

7. The nozzle of claim 1 wherein said nozzle has fore and aft ends, and said centerbody is axisymmetric and tapers toward said aft end in a truncated taper.

8. The nozzle of claim 1 wherein said nozzle is a multiple nozzle comprising a plurality of sub-nozzles, and each aperture of said second part is one of said sub-nozzles and comprises a convergent section, a throat, and a divergent section.

9. The nozzle of claim 8 wherein said sub-nozzles differ in cross-sectional area and wherein rotation of said first part closes sub-nozzles of a first cross-sectional area while allowing flow through sub-nozzles of a second cross-sectional area that differs from said first cross-sectional area.

10. The nozzle of claim 8 further comprising a central sub-nozzle in said centerbody.
